(19) United States
(12) Patent Application Publication
(10) Pub. No.: US 2025/0036774 A1
(43) Pub. Date: Jan. 30, 2025

(54) VULNERABILITY SCORING DEVICE, VULNERABILITY SCORING METHOD, AND VULNERABILITY SCORING PROGRAM

(71) Applicant: Nippon Telegraph and Telephone Corporation, Tokyo (JP)

(72) Inventor: Ryohei SATO, Musashino-shi, Tokyo (JP)

(21) Appl. No.: 18/713,718

(22) PCT Filed: Dec. 6, 2021
(86) PCT No.: PCT/JP2021/044770

§ 371 Date: May 28, 2024

(51) Int. Cl. G06F 21/57; G06F 21/55

(52) U.S. Cl. CPC G06F 21/577; G06F 21/552

(57) ABSTRACT

A model generation device of a vulnerability evaluation system acquires each of vulnerability data that has been disclosed from a database and an attack code that has been disclosed, and creates a calculation model for obtaining an exploit probability indicating a probability that the vulnerability is exploited according to an elapsed time from a disclosure time point of each of the vulnerability data that has been acquired, as a distribution of the elapsed time from the disclosure time point of each of the vulnerability data that has been acquired to a disclosure time point of the attack code for exploiting the vulnerability. A model evaluation device of the vulnerability evaluation system receives an input of the elapsed time from the disclosure time point of the vulnerability data to be evaluated, and obtains the exploit probability corresponding to the elapsed time that has been input based on the calculation model.

### TECHNICAL FIELD

The present invention relates to a vulnerability evaluation device, a vulnerability evaluation method, and a vulnerability evaluation program.

### BACKGROUND ART

Security metrics are evaluation measures for the purpose of security quantification and digitization. In order to correctly and efficiently perform security countermeasures of an information system, it is essential to quantitatively and accurately evaluate a security risk of the system by security metrics.

In general, the cyberattack is achieved by performing a plurality of unit attacks in a row (multi-step attack). Here, the unit attack is an attack that exploits a vulnerability inherent in a system and illegally obtains an operation authority or an access authority of a host. Therefore, in order to calculate the security risk of the entire system, it is necessary to accurately obtain the success probability of the unit attack.

Knowing the attack path (attack procedure) from the intrusion by unauthorized access from the outside to the target asset is important to know the security risk. Therefore, an attack graph (AG) is known as a graph comprehensively describing attack paths. Each node of the AG indicates a state of the system, and each edge (link between nodes) of the AG indicates a unit attack.

The expression form of the AG is classified into a state-based AG that does not consider the weight of the edge and a Bayesian AG (BAG) that gives the “success probability of the unit attack” to the edge with respect to the state-based AG. By creating the BAG of the information system, it is possible to calculate the risk probability of the information asset to be evaluated.

Non Patent Literature 1 clearly and specifically defines the BAG and an analysis method thereof. In Non Patent Literature 1, “a success probability of a unit attack” to be assigned to the BAG is calculated on the basis of a subjectivity of experts or common vulnerability scoring system (CVSS).

The CVSS is a universal evaluation scale that comprehensively evaluates a difficulty level of exploit, an influence on confidentiality, integrity, availability, and the like with respect to a vulnerability, and assigns a score (real value of 0 to 10) according to the risk level and severity. In the CVSS, various evaluation measures (element scores) are considered, and a final score is calculated by a dedicated calculation formula.

### CITATION LIST

### Non Patent Literature

Non Patent Literature 1: N. Poolsappasit, R. Dewri and I. Ray, “Dynamic Security Risk Management Using Bayesian Attack Graphs,” IEEE Transactions on Dependable and Secure Computing, vol. 9, no. 1, pp. 61-74, 2012.

### SUMMARY OF INVENTION

### Technical Problem

The success probability of the unit attack can also be said to be a probability that an external attacker can exploit each vulnerability inherent in the system (an exploit probability of a vulnerability). Therefore, in order to improve the evaluation accuracy of the security risk, it is necessary to improve the accuracy of the exploit probability of the vulnerability used for the calculation of the evaluation. However, in the conventional technology such as Non Patent Literature 1, a method for calculating the exploit probability of the vulnerability with high accuracy has not been proposed.

For example, Non Patent Literature 1 defines a calculation formula of the exploit probability based on the CVSS as (Expression 1).

Exploit probability=2×B_AV (access vector)×B_AC (access complexity)×B_AU (authentication) (Expression 1)

However, (Expression 1) is only a rough numerical value of the attack easiness (severity) of the system, and is not related to the exploit probability of the vulnerability. Therefore, the accuracy is not preferable when this severity is used as the exploit probability of the vulnerability.

As time elapses after a vulnerability is discovered and disclosed, an attack tool (code or script) for exploiting the vulnerability is easily developed and disclosed by an unspecified number of hackers, and the exploit probability of the vulnerability increases. Therefore, in order to improve the accuracy of the exploit probability of the vulnerability, it is necessary to consider the passage of time.

On the other hand, in a method in which an expert manually inputs an exploit probability for each vulnerability, accuracy of the probability depends on skill of the expert, and objectivity and uniqueness are lost. In addition, it is not practical to manually assign probabilities to all of a large amount of vulnerability information that is updated every day since human operation costs would be extremely high.

Therefore, a main object of the present invention is to improve evaluation accuracy of vulnerability.

### Solution to Problem

In order to solve the above problems, a vulnerability evaluation device of the present invention has the following features.

According to the present invention, a vulnerability evaluation device includes a model generation unit and a model evaluation unit,
in which the model generation unit
acquires each of vulnerability data that has been disclosed from a database and an attack code that has been disclosed,
creates a calculation model for obtaining an exploit probability indicating a probability that a vulnerability is exploited according to an elapsed time from a disclosure time point of each of the vulnerability data that has been acquired, as a distribution of the elapsed time from the disclosure time point of each of the vulnerability data that has been acquired to a disclosure time point of the attack code for exploiting the vulnerability, and
the model evaluation unit,
in response to an input of the elapsed time from the disclosure time point of the vulnerability data to be evaluated, obtains the exploit probability corresponding to the elapsed time that has been input on the basis of the calculation model created by the model generation unit.

### Advantageous Effects of Invention

According to the present invention, evaluation accuracy of a vulnerability can be improved.

### BRIEF DESCRIPTION OF DRAWINGS

FIG. 1 is a configuration diagram of a model generation device according to the present embodiment.

FIG. 2 is a detailed configuration diagram of a calculation model construction unit according to the present embodiment.

FIG. 3 is a configuration diagram of a model evaluation device according to the present embodiment.

FIG. 4 is a configuration diagram of a compromise evaluation device according to the present embodiment.

FIG. 5 is a hardware configuration diagram of each device of a vulnerability evaluation system according to the present embodiment.

FIG. 6 is a Venn diagram illustrating a relationship between sample sets stored in a database according to the present embodiment.

FIG. 7 is a table generated by a data processing unit from each sample of FIG. 6 according to the present embodiment.

FIG. 8 is a graph illustrating an example of a calculation result of a probability distribution construction unit according to the present embodiment.

FIG. 9 is a table illustrating descriptive statistics of the graph of FIG. 8 according to the present embodiment.

FIG. 10 is a graph for explaining a Weibull distribution according to the present embodiment.

FIG. 11 is a graph for explaining approximation by a Weibull distribution according to the present embodiment.

FIG. 12 is a graph for explaining approximation by a Weibull distribution F+ according to the present embodiment.

FIG. 13 is a graph for explaining approximation by a Weibull distribution F− according to the present embodiment.

FIG. 14 is a graph illustrating an experimental result for comparing a preceding method with a method of the present embodiment.

FIG. 15 is a graph illustrating an experimental result for comparing a preceding method with a method of the present embodiment.

FIG. 16 is a graph showing results of evaluating a compromise evaluation device according to the present embodiment.

### DESCRIPTION OF EMBODIMENTS

Hereinafter, one embodiment of the present invention will be described in detail with reference to the drawings.

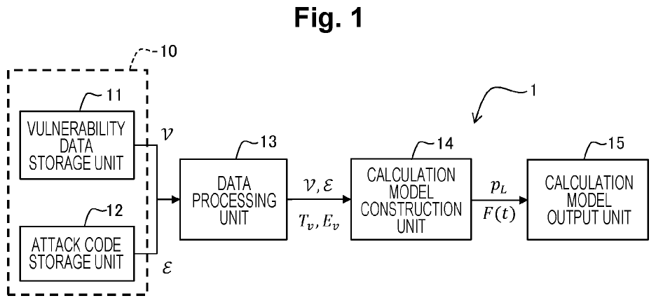

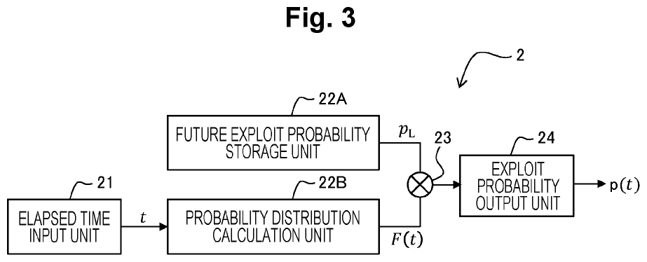

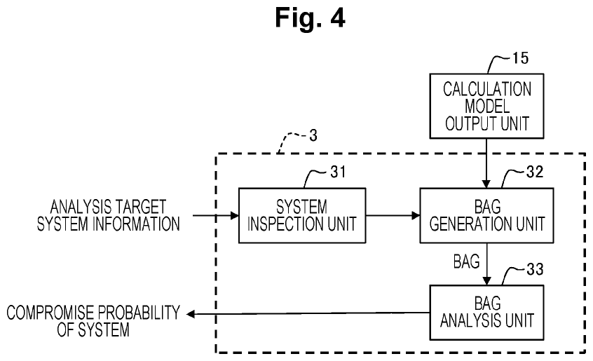

A vulnerability evaluation system according to the present embodiment includes a model generation device 1 in FIG. 1, a model evaluation device 2 in FIG. 3, and a compromise evaluation device 3 in FIG. 4. Each device of these vulnerability evaluation systems may be housed in the same housing called a vulnerability evaluation device. The vulnerability evaluation device includes some or all of a model generation unit having the function of the model generation device 1, a model evaluation unit having the function of the model evaluation device 2, and a compromise evaluation unit having the function of the compromise evaluation device 3.

FIG. 1 is a configuration diagram of the model generation device 1.

The model generation device 1 includes a database 10, a data processing unit 13, a calculation model construction unit 14, and a calculation model output unit 15.

The database 10 stores samples (hereinafter, a database (DB) sample) collected from the Internet or the like in the vulnerability data storage unit 11 and the attack code storage unit 12.

The model generation device 1 generates a model using the DB sample (actual data) of the existing database 10. Therefore, in a case where the DB sample is not available, it is necessary to collect the DB sample and store the DB sample in the vulnerability data storage unit 11 and the attack code storage unit 12. It is desirable that the number of DB samples serving as the material of the model is as large as possible.

It is also possible to limit the number and range of vulnerability data to any number and range, from the DB sample of the database 10. For example, “in order to analyze recent trends, disclosure dates of vulnerability are limited to those after 2017”.

The vulnerability data storage unit 11 stores a set of vulnerabilities “V”. The “vulnerability” is a defect in information security. Hereinafter, a certain vulnerability is referred to as “v”, and a set of vulnerabilities including the “v” is referred to as “V” (v E V). In order to correct the vulnerability, it is necessary to update the OS, apply a dedicated security patch, and the like.

The vulnerability data storage unit 11 is constructed as, for example, a national vulnerability database (NVD). The discovered major vulnerabilities are registered as samples in the NVD with a common vulnerabilities and exposures-ID (CVE-ID), which is a globally unique identifier. There are 169, 371 vulnerabilities registered in the NVD as of Aug. 28, 2021.

The attack code storage unit 12 stores a set of attack codes “ε”. The “attack codes” is a code or a tool for attacking vulnerability. Hereinafter, a certain attack code is “e”, and a set of attack codes including these “e” is “ε” (e∈ε). The attacker uses the attack code to perform an “exploit” action of attacking the vulnerability. Both the “exploit” and the attack code used for the exploit are also called “exploit”.

The attack code storage unit 12 is constructed as, for example, an exploit database (EDB). There are 44, 448 attack codes registered in the EDB as of Aug. 28, 2021.

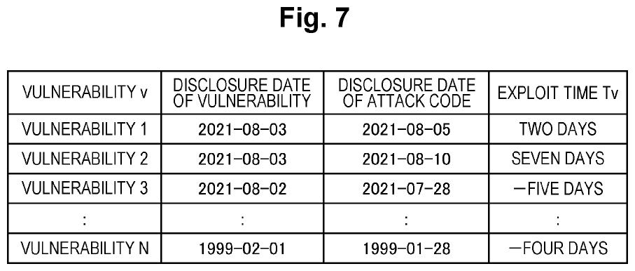

As described later with reference to FIG. 7, the data processing unit 13 shapes the DB samples of the database 10 into a data format that can be easily statistically processed by the calculation model construction unit 14.

The “exploit time Tv” for the exploit action is an elapsed time from the time point when a certain vulnerability v is disclosed in the vulnerability data storage unit 11 to the time point when the vulnerability is exploited. The “exploit time T” is obtained by generalizing the exploit time Tv to any vulnerability.

It is assumed that the attacker immediately exploits the attack code on the disclosure date of the attack code disclosed in the attack code storage unit 12. Therefore, in the present embodiment, the “Time Tv from disclosure of the vulnerability v to disclosure of the attack code e capable of attacking the vulnerability v” is regarded as the exploit time Tv.

When the vulnerability v does not have an attack code, the exploit time Tv is not defined. When the vulnerability v has a plurality of attack codes, a representative value such as a minimum value is selected as the exploit time Tv.

Hereinafter, a parameter Ev indicating whether the vulnerability v has the attack code e is defined. When Ev=1, the vulnerability v has the attack code e, and when Ev=0, the vulnerability v does not have the attack code e. A parameter Ev indicating whether the vulnerability v has the attack code e is generalized and the result is set as a parameter E indicating the exploit possibility of any vulnerability. If E=1, any vulnerability may be exploited (at some point in the future), and if E=0, this is not the case.

Hereinafter, the model generation device 1 generates a model obtained by generalizing the statistical feature of the exploit time Tv of the individual vulnerability v from the DB entry registered in the database 10. This model is a model for obtaining an exploit probability p(t) of any vulnerability currently existing.

The “exploit probability p(t)” is a probability that any vulnerability desired to be evaluated can be exploited by an attacker at a certain time point t from the disclosure date. The unit (for example, day, hour, minute, second) of the time point t may be determined to any by the user, but must be of a degree that can be acquired from the original data.

Even if the vulnerabilities v1, v2, v3, . . . are disclosed in the vulnerability data storage unit 11 on the same day, the vulnerability v1, v2, v3, . . . may have different exploit times.

For example, it is assumed that the attack code e1 for attacking the vulnerability v1 is disclosed in the attack code storage unit 12 one day after the disclosure date of the vulnerability v1. Then, it is assumed that the attack code e2 of the vulnerability v2 is disclosed after three days, and the attack code e3 of the vulnerability v3 is disclosed after five days. In this case, the exploit time is shortest in v1, and is longer in the order of v2 and v3.

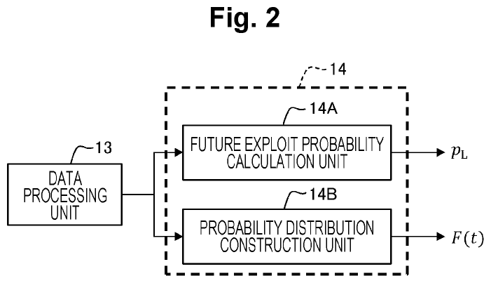

FIG. 2 is a detailed configuration diagram of the calculation model construction unit 14.

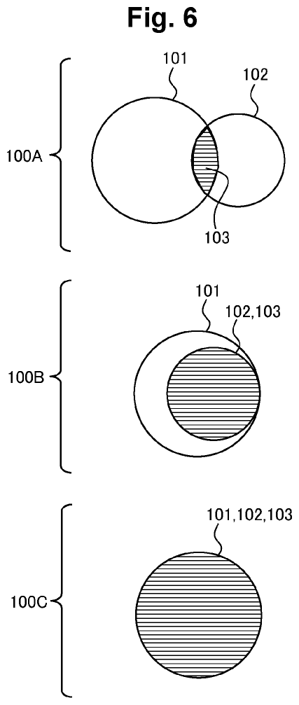

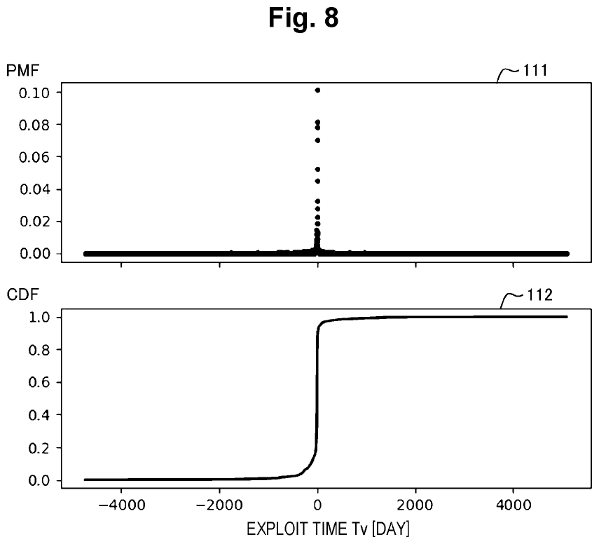

The calculation model construction unit 14 of the model generation device 1 models the exploit probability p(t) as the following two elements (1) and (2) by statistically processing the DB samples in the database 10.
(1) As described later with reference to FIG. 6, the future exploit probability calculation unit 14A calculates the future exploit probability pL on the basis of the number of DB samples in the database 10. The future exploit probability pL is a probability that any (future) attack code will be developed and disclosed by an unspecified number of hackers so that the vulnerability that is currently desired to be evaluated becomes a vulnerability that can be exploited (E=1).
(2) As described later with reference to FIG. 8, the probability distribution construction unit 14B calculates a cumulative distribution function F(t) of the probability distribution followed by the past exploit time T (actual measurement value), and stores the result in the probability distribution calculation unit 22B of FIG. 3. The cumulative distribution function F(t) indicates a conditional probability that a vulnerability determined by the future exploit probability calculation unit 14A to be at risk of being exploited (E=1) is to be exploited by a time t after being disclosed.

That is, the probability distribution construction unit 14B acquires each of the vulnerability data disclosed from the database 10 and the attack code disclosed. Then, the probability distribution construction unit 14B creates a calculation model for obtaining an exploit probability indicating a probability that the vulnerability is exploited according to an elapsed time from the disclosure time point of each piece of acquired vulnerability data as a distribution of elapsed times from the disclosure time point of each piece of acquired vulnerability data to the disclosure time point of the attack code for exploiting the vulnerability.

Then, as a calculation model for obtaining the exploit probability, the future exploit probability calculation unit 14A calculates, in addition to the distribution of the exploit times created by the probability distribution construction unit 14B, a future exploit probability that is a probability that the vulnerability to be evaluated will be used in the future, on the basis of a ratio of the number of samples of all pieces of vulnerability data and the number of samples of vulnerability data that can be used by the attack code.

FIG. 3 is a configuration diagram of the model evaluation device 2.

The model evaluation device 2 receives an input of an elapsed time from a disclosure time point of vulnerability data to be evaluated, and obtains exploit probability corresponding to the input elapsed time on the basis of a calculation model created by the model generation device 1. Therefore, the model evaluation device 2 includes an elapsed time input unit 21, a future exploit probability storage unit 22A, a probability distribution calculation unit 22B, an integration unit 23, and an exploit probability output unit 24.

The elapsed time input unit 21 receives an input of an elapsed time t and notifies the probability distribution calculation unit 22B of the input.

The future exploit probability storage unit 22A stores future exploit probability pL calculated by the future exploit probability calculation unit 14A.

The probability distribution calculation unit 22B stores a cumulative distribution function F(t) of the probability distribution followed by the past exploit time Tv (actual measurement value) calculated by the probability distribution construction unit 14B. Then, the probability distribution calculation unit 22B receives the input of the elapsed time t from the disclosure date of the vulnerability desired to be evaluated to the present, and substitutes the elapsed time t into the cumulative distribution function F(t) to calculate F(t) of the vulnerability desired to be evaluated.

The integration unit 23 calculates a product of the future exploit probability pL (read from the future exploit probability storage unit 22A)×the cumulative distribution function F(t) (read from the probability distribution calculation unit 22B) to obtain the exploit probability p(t).

That is, the model evaluation device 2 obtains the exploit probability p(t) indicating the probability that the vulnerability is exploited by integrating the value of the cumulative distribution function F(t) that is the result of calculation based on the input elapsed time t and the distribution (probability distribution F or the like) followed by the elapsed time and the value of the future exploit probability pL.

The exploit probability output unit 24 outputs the exploit probability p(t) obtained by the integration unit 23.

Hereinafter, a calculation example of the model evaluation device 2 will be described.

For example, it is assumed that today is Sep. 13, 2021. It is assumed that a vulnerability detection tool is applied to a certain information system and the following vulnerabilities (A), (B), and (C) are found. It is assumed that the CVE-ID and the disclosure date of each vulnerability are registered in the vulnerability data storage unit 11 (NVD) as follows.
(A) CVE-ID=CVE-2021-40524 (Sep. 5, 2021 NVD disclosed)
(B) CVE-ID=CVE-2021-39181 (Sep. 1, 2021 NVD disclosed)
(C) CVE-ID=CVE-2017-18877 (Jun. 19, 2020 NVD disclosed)

At this time, the elapsed time input unit 21 receives inputs of (A) 7 days, (B) 12 days, and (C) 451 days as the elapsed time t from the vulnerability disclosure as of September 13. When substituting these elapsed times t into F(t), the probability distribution calculation unit 22B obtains the probability F(t) as follows.

$$F ( 7 ) = P \{ Tv \leq 7 \vert Ev = 1 \} = 0.891833 \qquad ( A )$$

$$F ( 12 ) = P \{ Tv \leq 12 \vert Ev = 1 \} = 0.911164 \qquad ( B )$$

$$F ( 45 \; 1 ) = P \{ Tv \leq 451 \vert Ev = 1 \} = 0.983493 \qquad ( C )$$

The integration unit 23 reads the future exploit probability pL=0.268334 calculated in advance from the future exploit probability storage unit 22A, and obtains a product of F(t) of each of (A) to (C) calculated by the probability distribution calculation unit 22B to obtain an exploit probability p(t).

$$p ( 7 ) = p L \times F ( 7 ) = 0.268334 \times 0.891 \; 833 = 0.239309 \qquad ( A )$$

$$p ( 12 ) = p L \times F ( 12 ) = 0.268334 \times 0.911164 = 0.244496 \qquad ( B )$$

$$p ( 45 \; 1 ) = p L \times F ( 451 ) = 0.268334 \times 0.9834 \; 93 = 0.263905 \qquad ( C )$$

The exploit probability output unit 24 outputs the exploit probability p(t) calculated by the integration unit 23.

FIG. 4 is a configuration diagram of the compromise evaluation device 3.

The compromise evaluation device 3 improves the accuracy of the security risk analysis using the BAG by using the calculation model (future exploit probability pL, cumulative distribution function F(t)) output from the calculation model output unit 15 of the model generation device 1 as an element technology. Therefore, the compromise evaluation device 3 calculates the compromise probability of the target asset by calculation using the BAG using the calculation model output by the calculation model output unit 15. The “compromise” means that the final goal of the input attacker is achieved, for example, the root authority of the asset is taken away.

That is, the compromise evaluation device 3 calculates the exploit probability of each vulnerability included in the network model by applying the calculation model for obtaining the exploit probability of the vulnerability created by the model generation device 1 to the network model (BAG) including the dependency relationship among the plurality of vulnerabilities. The compromise evaluation device 3 calculates a compromise probability that is a probability that the input final goal of the attacker is achieved from the calculation result of the exploit probability.

Therefore, the compromise evaluation device 3 includes a system inspection unit 31, a BAG generation unit 32, and a BAG analysis unit 33.

A procedure in which the analyst analyzes the compromise of the system using the compromise evaluation device 3 will be described below.
(Procedure 1) The system inspection unit 31 acquires configuration management information, vulnerability information, and the like of a system to be analyzed from an analyst. Therefore, the analyst defines the “range of the system” and the “target (final goal of the attacker)” when actually performing the analysis using the BAG as exemplified below.
A probability that the root authority of the administrator terminal is deprived is obtained as a compromise probability.
A probability that the user authority of the user terminal is deprived is obtained as a compromise probability.

The system inspection unit 31 outputs system information (for example, network information or vulnerability information) necessary for BAG generation to the BAG generation unit 32.
(Procedure 2) The BAG generation unit 32 generates a BAG of the system to be analyzed using the calculation model output by the calculation model output unit 15, and outputs the BAG to the BAG analysis unit 33.
(Procedure 3) The BAG analysis unit 33 calculates the compromise probability (for example, the probability that the route authority is deprived) of the target asset (for example, the administrator terminal) by calculation using the BAG. Since the BAG generated by the BAG generation unit 32 includes a calculation model for obtaining the exploit probability of the vulnerability existing in the system with high accuracy, the accuracy of the compromise probability can also be improved. The exploit probability of the vulnerability in the BAG is, for example, a probability of breaking through a node representing the vulnerability.

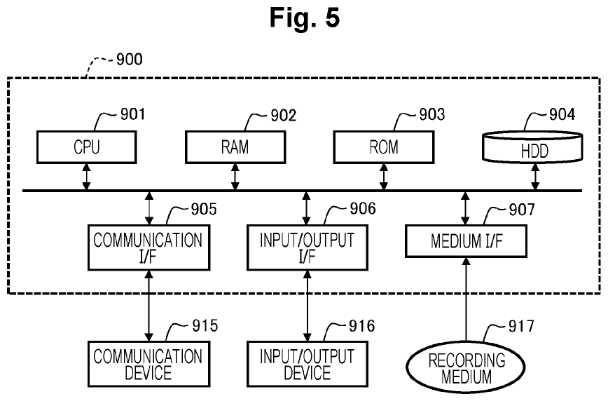

FIG. 5 is a hardware configuration diagram of each device of the vulnerability evaluation system.

Each device (model generation device 1, model evaluation device 2, compromise evaluation device 3) of the vulnerability evaluation system is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. Moreover, the CPU 901 controls each processing unit by executing a program (also referred to as an application or an app for abbreviation thereof) read into the RAM 902. Then, the program can be distributed via a communication line or recorded in the recording medium 917 such as a CD-ROM and distributed.

FIG. 6 is a Venn diagram illustrating a relationship between sample sets stored in the database 10.

As described below, the future exploit probability calculation unit 14A calculates the future exploit probability pL on the basis of the number of past DB entries in the database 10.

A set 101 indicates a sample set stored in the vulnerability data storage unit 11. A set 102 indicates a sample set stored in the attack code storage unit 12. A set 103 indicates a product set of the set 101 and the set 102.

The samples of the set 101 are classified into the samples belonging to the set 103 (the samples having the attack code among the vulnerability samples) or the samples not belonging to the set 103 (the samples having no attack code among the vulnerability samples).

The samples of the set 102 are classified into samples belonging to the set 103 (samples whose attack target is the vulnerability sample in the attack code) or samples not belonging to the set 103 (samples whose attack target is not the vulnerability sample in the attack code).

A method in which the future exploit probability calculation unit 14A calculates the future exploit probability pL will be exemplified as (Method 1) to (Method 3).
[Method 1] A symbol 100A is a case where a part of the set 101 belongs to the set 103, and a part of the set 102 belongs to the set 103. A ratio of all vulnerability samples (set 101) having the attack code (set 103) is set as the future exploit probability pL (Expression 2).

$$\begin{matrix}[ Math . 1 ] & \\ {p}_{L} = P \{ E = 1 \} = P \{ {E}_{v} = 1 \} = \frac{{\sum }_{v ∈ 𝒱} {E}_{v}}{\vert 𝒱 \vert} . & ( Expression 2 )\end{matrix}$$

[Method 2] A symbol 100B is a case where a part of the set 101 belongs to the set 103, and all of the set 102 belong to the set 103. A ratio of the number of all attack code samples (set 101) to the number of all vulnerability samples (set 102) is set as the future exploit probability pL (Expression 3). Since this is a more pessimistic estimation than Method 1, it is possible to prevent the risk evaluation from being optimistic.

$$\begin{matrix}[ Math . 2 ] & \\ {p}_{L} = P \{ E = 1 \} = \{ \begin{matrix}\frac{\vert ε \vert}{\vert 𝒱 \vert} & if \vert 𝒱 \vert > \vert ε \vert , \\ 1 & if \vert 𝒱 \vert \leq \vert ε \vert .\end{matrix} & ( Expression 3 )\end{matrix}$$

[Method 3] A symbol 100C is a case where sets 101, 102, 103 are the same set. It is assumed that all vulnerabilities are necessarily exploited (Expression 4). This is a more pessimistic estimation than Method 2. In other words, since the method 3 is the exploit probability p(t)=the cumulative distribution function F(t), the future exploit probability calculation unit 14A of the model generation device 1, the future exploit probability storage unit 22A of the model evaluation device 2, and the integration unit 23 can be omitted.

$$pL = P \{ E = 1 \} = 1 \qquad ( Expression 4 )$$

For example, assuming that the set 101=169,371 samples, the set 102=45,448 samples, and the set 103=9207 samples, the future exploit probability calculation unit 14A calculates the future exploit probability pL as follows.

$$[ Method 1 ] pL = 9207 / 169 , 371 = 0.0544$$

$$[ Method 2 ] pL = 45 , 448 / 169 , 371 = 0.268$$

$$[ Method 3 ] pL = 1$$

FIG. 7 is a table generated by the data processing unit 13 from each sample of FIG. 6.

The data processing unit 13 organizes and shapes data so that the calculation model construction unit 14 can easily perform processing. Specifically, the data processing unit 13 acquires the disclosure date and time of the vulnerability v for each sample of the vulnerability data storage unit 11. The data processing unit 13 acquires the disclosure date and time of the attack code e for each sample of the attack code storage unit 12.

Then, with respect to the sample of the vulnerability v (the set 103 in FIG. 6) having the attack code e, the data processing unit 13 calculates the exploit time Tv on the basis of the disclosure date and time information of the DB sample, and adds the exploit time Tv as a new attribute (item) of the table in FIG. 7. The exploit time Tv is a time from the date and time of disclosure of the vulnerability v to the date and time of disclosure of the attack code e to the vulnerability v (the date and time when the attack code e is considered to be exploited by disclosure), and in a case where the attack code is already exploited before the vulnerability is disclosed, the exploit time Tv is a negative number.

There is a possibility that there is an error between the disclosure date and time of the attack code and the development date and time when the attack code is actually developed. When the actual development date and time is available, the data processing unit 13 may obtain a more accurate “exploit time” by using the development date and time.

Processing of associating the vulnerability v with the attack code e will be described.

The vulnerability sample of the NVD has its reference link if the corresponding attack code is present in the EDB. Therefore, in a case where the source is the NVD and the EDB, the data processing unit 13 can integrate data by using, for example, a reference link from the NVD to the EDB.

That is, among the vulnerabilities disclosed in the NVD, a vulnerability having a reference link to the EDB is assumed to be a vulnerability in which “attack code is available (exploited)”. When a plurality of attack codes is referred to, one with the earliest disclosure date and time is adopted.

On the other hand, when the vulnerability information and the attack code information are acquired from different sources (information sources), the data processing unit 13 needs an attribute (for example, a reference link from one to the other, an identifier common to both) for integrating these pieces of data separately in addition to the above attributes.

As described above, the entries in the table of FIG. 7 are classified into the following three types.
(1) Vulnerability samples without attack code
(2) Attack code sample whose corresponding vulnerability is unknown
(3) Vulnerability samples with attack code (corresponds to the set 103 of FIG. 6, and FIG. 7 illustrates all of this classification)

The probability distribution construction unit 14B obtains a probability distribution of the exploit time Tv regarding the vulnerability sample of (3) and generalizes the result as a probability distribution F of the exploit time regarding any vulnerability.

FIG. 8 is a graph illustrating an example of a calculation result of the probability distribution construction unit 14B.

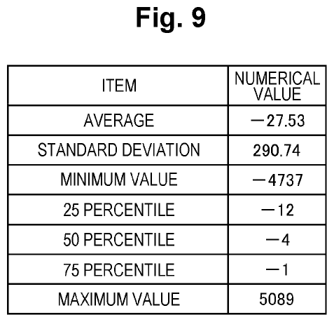

FIG. 9 is a table illustrating descriptive statistics of a graph 112 of FIG. 8.

A graph 111 illustrates f(t) that is a probability mass function (PMF) of the probability distribution F.

The graph 112 illustrates F(t) that is a cumulative distribution function (CDF) of the probability distribution F.

The probability distribution construction unit 14B calculates f(t) using (Expression 5) and calculates F(t) using (Expression 6).

$$\begin{matrix}[ Math . 3 ] & \\ f ( t ) = P \{ {T}_{v} = t \vert {E}_{v} = 1 \} = \frac{{\sum }_{\{ u \vert {T}_{u} = t , u ∈ 𝒱 \}} {E}_{u}}{{\sum }_{v ∈ 𝒱} {E}_{v}} & ( Expression 5 )\end{matrix}$$

$$F ( t ) = P \{ {T}_{v} \leq t \vert {E}_{v} = 1 \} = {\sum }_{τ = - ∞}^{t} f ( τ ) . \qquad ( Expression 6 )$$

As described above up to FIG. 9, the probability distribution construction unit 14B creates the calculation model (probability distribution F) as the model (actual measurement model) created based on the actual measurement values of the DB samples. This actual measurement model can be calculated with high accuracy when a sufficient number of DB samples can be acquired.

On the other hand, in the actual measurement model when the number of DB samples is not sufficient, the PMF oscillates and F(t) that is the CDF is not smooth, so that the accuracy of the probability distribution F may be insufficient. In other words, when the number of DB samples is not sufficient, probability calculation can be performed more accurately (appropriately) by using an approximate model based on any probability distribution.

Therefore, the probability distribution construction unit 14B may approximate the probability distribution F by any probability distribution instead of the actual measurement model of the probability distribution F, and use the CDF of the approximate model instead of F(t). Hereinafter, an example in which the probability distribution construction unit 14B uses a Weibull distribution as an approximate model and creates G(t) that is the CDF will be described.

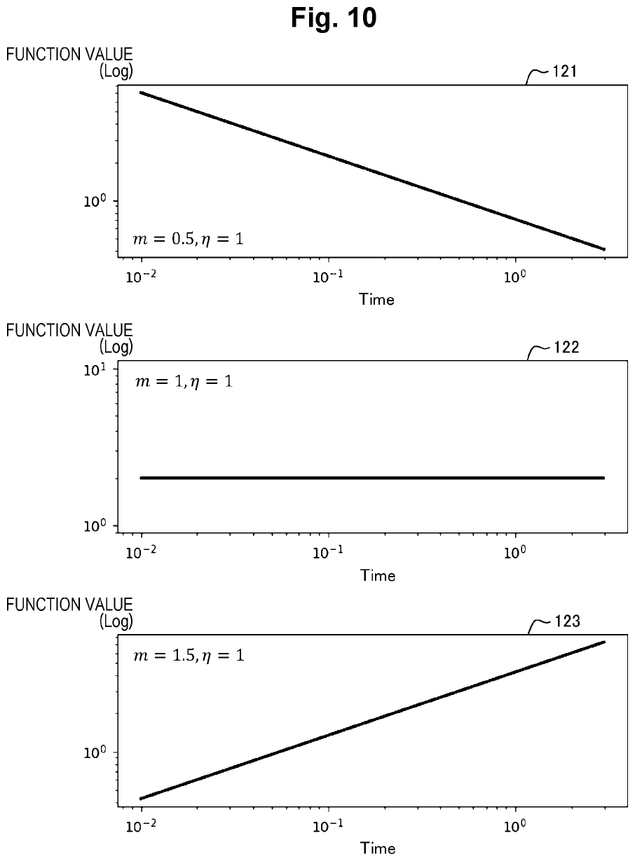

FIG. 10 is a graph for explaining a Weibull distribution.

The Weibull distribution is generally known as a distribution according to a failure time (that is, the product life) of a product or the like. The intensity function (Expression 7) of the Weibull distribution indicates a (instantaneous) failure rate at time t. This failure rate represents the frequency of occurrence of failures per unit time, not the probability of occurrence of failures. Depending on the value of a Weibull coefficient m, a failure rate A(t) changes its behavior as follows.

The Weibull distribution is determined by two Weibull parameters “m, η” expressed in (Expression 7). m is a Weibull coefficient (shape parameter), and η is a scale parameter.

$$\begin{matrix}[ Math . 4 ] & \\ λ ( t ) = \frac{m}{{η}^{m}} {t}^{m - 1} & ( Expression 7 )\end{matrix}$$

In the graph 121 when the Weibull coefficient m<1, the failure rate decreases with time, as at the left end of the bathtub curve. The graph 121 is used for modeling an initial failure (failure due to an initial failure).

In the graph 122 when the Weibull coefficient m=1 (at this time, the Weibull distribution has the same value as the exponential distribution), as in the intermediate portion of the bathtub curve, the failure rate is constant regardless of the lapse of time. The graph 122 is used for modeling an accidental failure such as a failure due to a disaster or an accident.

In the graph 123 when the Weibull coefficient m>1, the failure rate increases with time, as at the right end of the bathtub curve. The graph 123 is used for modeling a failure due to wear such as a failure due to aging.

In the approximate model of the Weibull distribution, first, the probability distribution F is divided into the region of the vulnerability exploit time T>0 and the region of T<0. First, for the probability distribution F+ in which the exploit time T>0, f+(t) that is the PMF is illustrated in (Expression 8), and F+(t) that is the CDF is illustrated in (Expression 9).

$$\begin{matrix}[ Math . 5 ] & \\ {f}_{+} ( t ) = P \{ T = t \vert T > 0 , E = 1 \} = P ( {T}_{v} = t \vert {T}_{v} > 0 , {E}_{v} = 1 \} = \frac{{\sum }_{\{ u \vert {T}_{u} = t , {T}_{u} > 0 , u ∈ 𝒱 \}} {E}_{u}}{{\sum }_{\{ v \vert {T}_{v} > 0 , v ∈ 𝒱 \}} {E}_{v}} & ( Expression 8 )\end{matrix}$$

$${F}_{+} ( t ) = P \{ T \leq t \vert T > 0 , E = 1 \} = P ( {T}_{v} = t \vert {T}_{v} \leq t \vert {T}_{v} > 0 , {E}_{v} = 1 \} = {\sum }_{τ = 0}^{t} {f}_{+} ( τ ) \qquad ( Expression 9 )$$

Next, for the probability distribution F− in which the exploit time T<0, f−(t) that is the PMF is illustrated in (Expression 10), and F−(t) that is the CDF is illustrated in (Expression 11). However, the probability distribution F− is a distribution of absolute values of T, and the domain is a positive number.

$$\begin{matrix}[ Math . 6 ] & \\ {f}_{-} ( t ) = P \{ \vert T \vert = t \vert T < 0 , E = 1 \} = P ( \vert {T}_{v} \vert = t \vert {T}_{v} < 0 , {E}_{v} = 1 \} = \frac{{\sum }_{\{ u \vert {T}_{u} = t , {T}_{u} > 0 , u ∈ 𝒱 \}} {E}_{u}}{{\sum }_{\{ v \vert {T}_{v} > 0 , v ∈ 𝒱 \}} {E}_{v}} & ( Expression 10 )\end{matrix}$$

$${F}_{-} ( t ) = P \{ \vert T \vert \leq t \vert T < 0 , E = 1 \} = P ( \vert {T}_{v} \vert \leq t \vert {T}_{v} < 0 , {E}_{v} = 1 \} = {\sum }_{τ = 0}^{t} {f}_{-} ( τ ) . \qquad ( Expression 11 )$$

h(t), which is the PMF of the Weibull distribution using the Weibull parameter, is expressed in (Expression 12), and H(t), which is the CDF, is expressed in (Expression 13).

$$h ( t ) = \frac{m}{η} {( \frac{t}{η} )}^{m - 1} exp \{ - {( \frac{t}{η} )}^{m} \} \qquad ( Expression 12 )$$

$$H ( t ) = 1 - exp \{ - {( \frac{t}{η} )}^{m} \} \qquad ( Expression 13 )$$

The probability distribution construction unit 14B identifies a Weibull parameter “m, η” most suitable for the actual measurement value by calculation of a Weibull plot. Hereinafter, a calculation formula of the Weibull plot will be described.

First, when CDF is set to (Expression 14), “Y=mx−m ln η” is established. Then, linear approximation is performed on Y obtained from the actual measurement value, and the parameter m can be identified from the inclination of the straight line. Thereafter, the parameter η can be identified by substituting m into (Expression 15).

$$\begin{matrix}[ Math . 8 ] & \\ \begin{matrix}Y = ln ( ln \frac{1}{1 - H ( t )} ) \\ X = ln t\end{matrix} & ( Expression 14 )\end{matrix}$$

$$η = exp \{ X - \frac{Y}{m} \} \qquad ( Expression 15 )$$

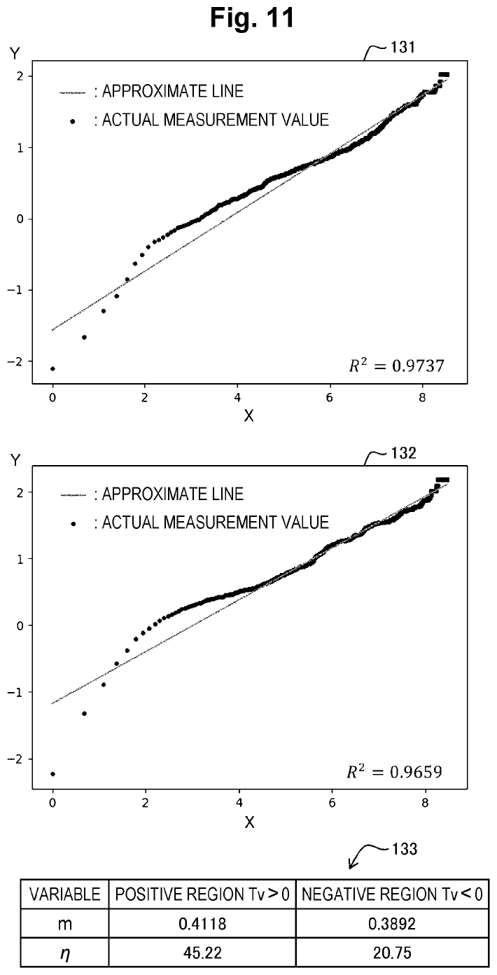

FIG. 11 is a graph for explaining approximation by a Weibull distribution.

A graph 131 is an execution result of the Weibull plot for the DB samples belonging to the positive area Tv>0.

A graph 132 is an execution result of the Weibull plot for the DB samples belonging to the negative area Tv<0.

A table 133 shows the Weibull parameters “m, η” obtained by the graph 131 and the graph 132.

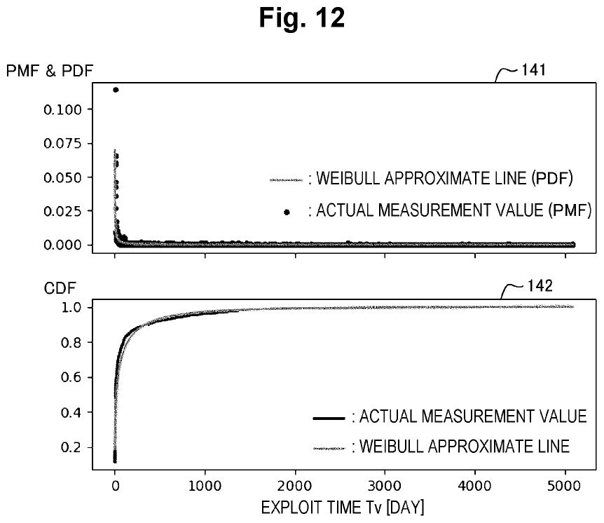

FIG. 12 is a graph for explaining approximation by the probability distribution F+ according to the Weibull distribution G+.

A graph 141 shows an approximate line (PDF) according to the Weibull distribution G+ and actual measurement values (PMF) used for the calculation of the approximate line.

A graph 142 shows the CDF of the Weibull distribution G+.

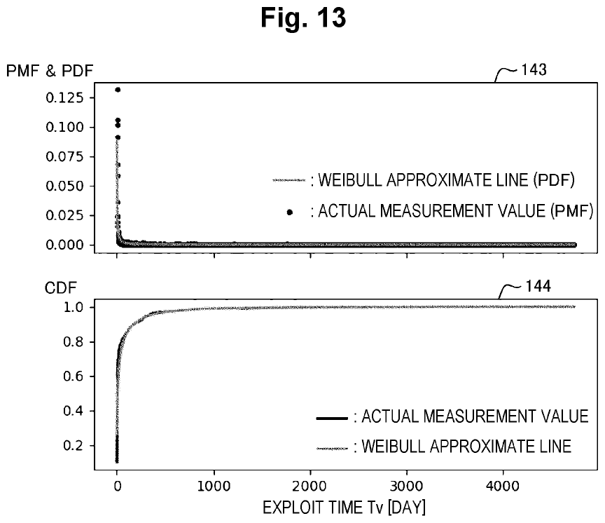

FIG. 13 is a graph for explaining approximation of the probability distribution F− by the Weibull distribution G−.

A graph 143 shows an approximate line (PDF) according to the Weibull distribution G− and actual measurement values (PMF) used for the calculation of the approximate line.

A graph 144 shows the CDF of the Weibull distribution G−.

The probability distribution construction unit 14B obtains the optimum Weibull parameter “m+, η+” of the Weibull distribution that approximates the distribution F+ by the Weibull plot. As similar to this, the probability distribution construction unit 14B obtains the optimum Weibull parameter “m−, η−” of the Weibull distribution that approximates the distribution F− by the Weibull plot. As a result, the optimal Weibull distribution G+ that approximates the distribution F+ can be obtained by (Expression 16). The optimal Weibull distribution G− that approximates the distribution F− can be obtained by (Expression 17).

$$\begin{matrix}[ Math . 9 ] & \\ {G}_{+} ( t ) = 1 - exp \{ - {( \frac{t}{{η}_{+}} )}^{{m}_{+}} \} , & ( Expression 16 )\end{matrix}$$

$${G}_{-} ( t ) = 1 - exp \{ - {( \frac{t}{{η}_{-}} )}^{\} {m}_{-}} \} . \qquad ( Expression 17 )$$

At this time, the probability distribution construction unit 14B calculates G(t) that substitutes F(t) by (Expression 18).

$$\begin{matrix}[ Math . 10 ] & \\ G ( t ) = \{ \begin{matrix}{p}_{-} + {p}_{0} + {p}_{+} \times {G}_{+} ( t ) & if t > 0 , \\ {p}_{-} + {p}_{0} & if t = 0 , \\ {p}_{-} \times ( 1 - {G}_{-} ( t ) ) & if t < 0.\end{matrix} & ( Expression 18 )\end{matrix}$$

Here, p−, p0, and p+ in (Expression 18) indicate probabilities that the exploit time becomes a negative number, 0, and a positive number, respectively (Expression 19).

$$\begin{matrix}[ Math . 11 ] & \\ \begin{matrix}{p}_{-} = P \{ T < 0 \vert E = 1 \} = P \{ {T}_{v} < 0 \vert {E}_{v} = 1 \} = \frac{{\sum }_{[ u \vert {T}_{u} < 0 , u ∈ 𝒱 \}} {E}_{u}}{{\sum }_{v ∈ 𝒱} {E}_{v}} , \\ {p}_{0} = P \{ T = 0 \vert E = 1 \} = P \{ {T}_{v} = 0 \vert {E}_{v} = 1 \} = \frac{{\sum }_{{\{ u \vert T u = 0 , u ∈ 𝒱 \}}^{{E}_{u}}}}{{\sum }_{v ∈ {𝒱}^{{E}_{v}}}} , \\ {p}_{+} = P \{ T > 0 \vert E = 1 \} = P \{ {T}_{v} > 0 \vert {E}_{v} = 1 \} = \frac{{\sum }_{\{ u \vert {T}_{u} > 0 , u ∈ 𝒱 \}} {E}_{u}}{{\sum }_{v ∈ 𝒱} {E}_{v}} .\end{matrix} & ( Expression 19 )\end{matrix}$$

The vulnerability evaluation system according to the present embodiment has been described above with reference to drawings up to FIG. 13. Hereinafter, experimental results of evaluating the effectiveness of the vulnerability evaluation system will be described.

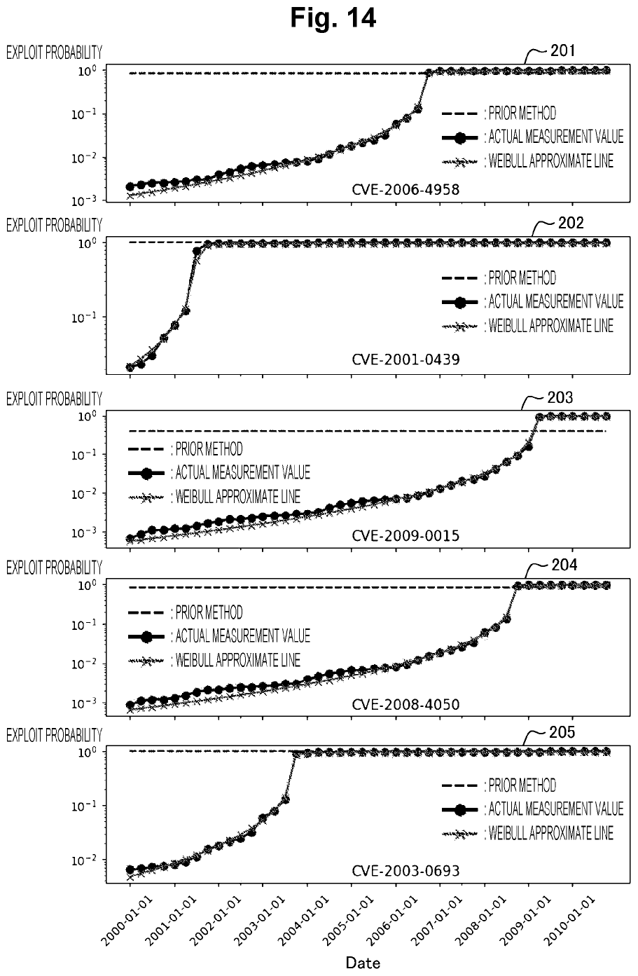

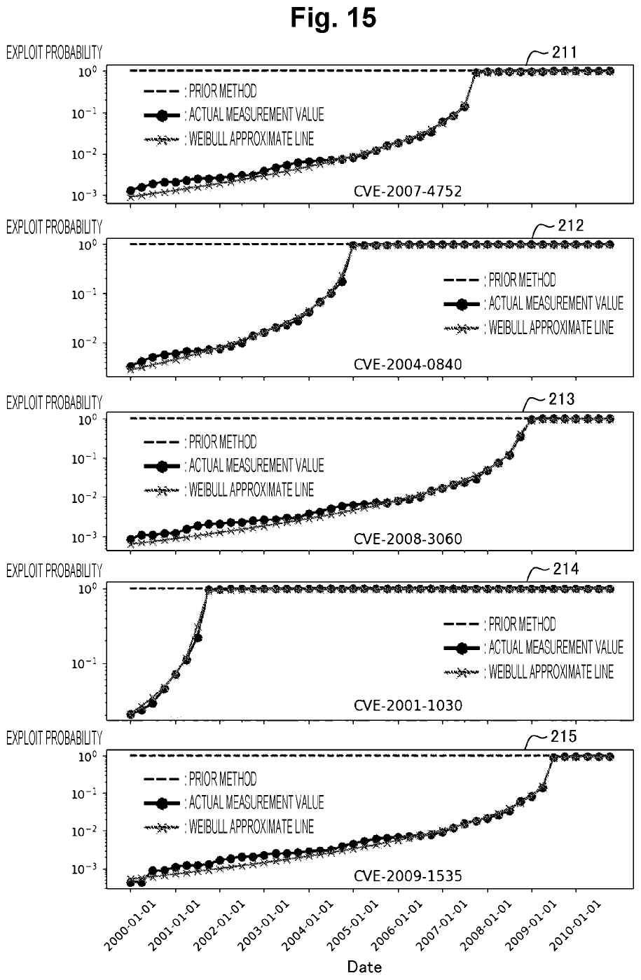

FIGS. 14 and 15 are graphs showing experimental results.

First, the experimental environment is as follows.
The test network of Non Patent Literature 1 was used, and it was assumed that various vulnerabilities of Tab. 1 of Non Patent Literature 1 exist in each host of the network illustrated in FIG. 1 of Non Patent Literature 1. However, since information relating to vulnerability “CA 1996-83” was not found, CVE-2006-4958 was used as a substitute.
The BAG for the test network of Non Patent Literature 1 was also cited. When the test network of Non Patent Literature 1 is rewritten in the BAG, FIG. 2 of Non Patent Literature 1 is obtained.
As a condition for the compromise of the test network, the final goal of the attacker was to deprive root authority of Admin Machine (10.0.0.128). The compromise probability of the Admin Machine in a case where it is assumed that an attacker is present was calculated.
For each vulnerability, the exploit probability was calculated every three months from 2000 to 2010. In the graph 201 to 205 of the experimental result, the horizontal axis represents day, and the vertical axis represents the exploit probability calculated by the system.

The graphs 201 to 205 of FIG. 14 and the graphs 211 to 215 of FIG. 15 have different target vulnerabilities. For example, the graph 201 is an experimental result of the vulnerability of CVE-ID=CVE-2006-4958. In each of the graphs 201 to 205 and the graphs 211 to 215, lines indicating the following three types of experimental results are described.
As a prior method, as disclosed in Non Patent Literature 1, a method using a calculation expression (Expression 1) of an exploit probability based on the CVSS.
As a first method of the present embodiment, the probability distribution construction unit 14B uses F(t) that is the CDF of the probability distribution of the actual measurement value.
As a second method of the present embodiment, the probability distribution construction unit 14B uses an approximate line, that is, G(t) which is the CDF of Weibull distribution.

Hereinafter, matters that can be read from each graph of FIGS. 14 and 15 will be listed.
Unlike the prior technology of Non Patent Literature 1, the actual measurement value and the approximate line of the present embodiment both increase in the exploit probability over time. That is, the actual measurement value and the approximate line of the present embodiment take into account a change in time.
The approximate line of the present embodiment closely approximates a model based on actual measurement values.
In the graph 203 and the like, the prior method optimistically (to a lower value) calculates the exploit probability than the proposed method.

Note that the CVSS used in Non Patent Literature 1 is originally a metric for evaluating the severity of vulnerability, and is not intended to reflect probability. Therefore, the value obtained by (Expression 1) of Non Patent Literature 1 is a value that “looks like probability” taking a range of 0 to 1, and has no probability statistical basis.

On the other hand, in the present embodiment, the actual probability distribution F is obtained from the enormous sample of the database 10, and the exploit probability p(t) is calculated on the basis of the probability distribution F. Therefore, it is possible to calculate the exploit probability p(t) closer to the true probability (with higher accuracy) than the method of Non Patent Literature 1.

A vulnerability that has been disclosed for a longer time is more likely to be exploited than a vulnerability that has just been disclosed due to an increase in the development period of the attack code. However, in the method of Non Patent Literature 1, since the exploit probability is obtained from the CVSS, a constant value is always calculated without considering the lapse of time until the evaluation time point.

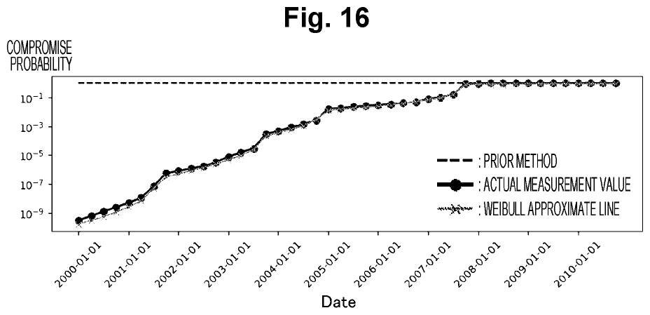

FIG. 16 is a graph showing results of evaluating the compromise evaluation device 3.

This graph shows a result of calculating the compromise probability every three months from 2000 to 2010 for the Admin Machine. As similar to the graphs of FIGS. 14 and 15, also in the graph of FIG. 16, the actual measurement value and the approximate line of the present embodiment take into consideration the change in time, unlike the prior method of Non Patent Literature 1. Also in the graph of FIG. 16, the approximate line of the present embodiment closely approximates a model based on actual measurement values.

### Effects

A vulnerability evaluation system of the present invention includes a model generation device 1 and a model evaluation device 2,
in which the model generation device 1
acquires each of disclosed vulnerability data that has been disclosed from a database 10 and an attack code that has been disclosed,
creates a calculation model for obtaining an exploit probability indicating a probability that a vulnerability is exploited according to an elapsed time from a disclosed time of each of the vulnerability data that has been acquired, as a distribution of elapsed times from a disclosed time of each of the vulnerability data that has been acquired to a disclosed time of the attack code for exploiting the vulnerability, and
the model evaluation device 2,
in response to an input of an elapsed time from a disclosure time point of vulnerability data to be evaluated, obtains an exploit probability corresponding to the input elapsed time on the basis of a calculation model created by the model generation device 1.

As a result, the model generation device 1 creates a calculation model capable of statistically calculating a probability that an attacker can exploit a vulnerability inherent in software or hardware on the basis of the information of the database 10. Therefore, the model evaluation device 2 can obtain the exploit probability with high accuracy at the time of evaluation in consideration of the increase in the exploit probability with the lapse of time from the disclosure of the vulnerability. Furthermore, the evaluation value can be automatically and mechanically calculated as compared with a method in which an expert manually inputs the evaluation value based on his/her experience, and the required human operation cost can be saved.

The present invention is characterized in that the model generation device 1 calculates, as a calculation model for obtaining an exploit probability, a future exploit probability that is a probability that a vulnerability to be evaluated is to be exploited in the future on the basis of a ratio of the number of samples of all pieces of vulnerability data and the number of samples of vulnerability data that can be exploited by an attack code, in addition to a distribution of elapsed time, and
the model evaluation device 2 obtains an exploit probability indicating a probability that a vulnerability is exploited by integrating a value of a result calculated from an input elapsed time and a distribution according to the elapsed time and a value of the future exploit probability.

As a result, by referring to the number of actual samples in the database 10, a rough tendency of the probability of being exploited in the future is reflected in the calculation model. Therefore, a true (highly accurate) exploit probability is obtained in which objectivity and uniqueness are ensured.

The present invention is characterized in that the model generation device 1 generates a calculation model in which an elapsed time distribution is approximated by a Weibull distribution, and
the model evaluation device 2 obtains an exploit probability corresponding to an input elapsed time on the basis of the calculation model approximated by the Weibull distribution instead of the distribution of the elapsed time.

As a result, by approximating the distribution of the exploit time obtained from the actual data of the database 10 by the Weibull distribution, which is a general probability distribution, a valid calculation model can be constructed even when the number of samples of the database 10 is small.

The present invention is characterized in that the vulnerability evaluation system further includes the compromise evaluation device 3, and
the compromise evaluation device 3
calculates an exploit probability of each vulnerability included in a network model by applying a calculation model for obtaining an exploit probability of the vulnerability created by the model generation device 1 to the network model including a plurality of dependency relationships of the vulnerabilities, and calculates a compromise probability that is a probability that an input final goal of an attacker is achieved from a result of the calculation.

As a result, in the network model of the BAG, the final compromise probability is calculated in consideration of the dependency relationship between the plurality of vulnerabilities. Therefore, by increasing the accuracy of the exploit probability of each vulnerability, the accuracy of the compromise probability can also be increased.

### REFERENCE SIGNS LIST

1 Model generation device (model generation unit)
2 Model evaluation device (model evaluation unit)
3 Compromise evaluation device (compromise evaluation unit)
10 Database
11 Vulnerability data storage unit
12 Attack code storage unit
13 Data processing unit
14 Calculation model construction unit
14A Future exploit probability calculation unit
14B Probability distribution construction unit
15 Calculation model output unit
21 Elapsed time input unit
22A Future exploit probability storage unit
22B Probability distribution calculation unit
23 Integration unit
24 Exploit probability output unit
31 System inspection unit
32 BAG Generation unit
33 BAG analysis unit

1. A vulnerability evaluation device comprising a model generation unit and a model evaluation unit,
wherein the model generation unit, comprising one or more processors, is configured to
acquire each of vulnerability data that has been disclosed from a database and an attack code that has been disclosed, and
create a calculation model for obtaining an exploit probability indicating a probability that a vulnerability is exploited according to an elapsed time from a disclosure time point of each of the vulnerability data that has been acquired, as a distribution of the elapsed time from the disclosure time point of each of the vulnerability data that has been acquired to a disclosure time point of the attack code for exploiting the vulnerability, and
the model evaluation unit, comprising one or more processors, is configured to,
in response to an input of the elapsed time from the disclosure time point of the vulnerability data to be evaluated, obtain the exploit probability corresponding to the elapsed time that has been input based on the calculation model created by the model generation unit.

2. The vulnerability evaluation device according to claim 1,
wherein the model generation unit is configured to calculate, as the calculation model for obtaining the exploit probability, a future exploit probability that is a probability that the vulnerability to be evaluated is to be exploited in the future based on a ratio of the number of samples of all pieces of the vulnerability data and the number of samples of the vulnerability data that can be exploited by the attack code, in addition to the distribution of the elapsed time, and
the model evaluation unit is configured to obtain the exploit probability indicating the probability that the vulnerability is exploited by integrating a value of a result of calculation from the elapsed time that has been input and a distribution followed by the elapsed time and a value of the future exploit probability.

3. The vulnerability evaluation device according to claim 1,
wherein the model generation unit is configured to generate a calculation model in which the distribution of the elapsed time is approximated by a Weibull distribution, and
the model evaluation unit is configured to obtain the exploit probability corresponding to the elapsed time that has been input based on the calculation model approximated by the Weibull distribution instead of the distribution of the elapsed time.

4. The vulnerability evaluation device according to claim 1, further comprising a compromise evaluation unit comprising one or more processors, wherein
the compromise evaluation unit is configured to
calculate the exploit probability of each of the vulnerability included in a network model by applying the calculation model for obtaining the exploit probability created by the model generation unit to the network model including a plurality of dependency relationships of the vulnerability, and calculate a compromise probability that is a probability that an input final goal of an attacker is achieved from a result of the calculation.

5. A vulnerability evaluation method, wherein a vulnerability evaluation device includes a model generation unit and a model evaluation unit,
the vulnerability evaluation method comprising:
acquiring, by the model generation unit, each of vulnerability data that has been disclosed from a database and an attack code that has been disclosed;
creating, by the model generation unit, a calculation model for obtaining an exploit probability indicating a probability that the vulnerability is exploited according to an elapsed time from a disclosure time point of each of the vulnerability data that has been acquired, as a distribution of the elapsed time from the disclosure time point of each of the vulnerability data that has been acquired to a disclosure time point of the attack code for exploiting the vulnerability; and
in response to an input of the elapsed time from the disclosure time point of vulnerability data to be evaluated, obtaining, by the model evaluation unit, the exploit probability corresponding to the elapsed time that has been input based on the calculation model created by the model generation unit.

6. A non-transitory computer readable medium storing a program, wherein execution of the program causes a computer to function as the vulnerability evaluation device according to claim 1.
